(19) United States
(12) Patent Application Publication
(10) Pub. No.: US 2020/0284694 A1
(43) Pub. Date: Sep. 10, 2020

(54) Machine Monitoring

(71) Applicant: MOVUS Australia Pty Ltd, Spring Hill, QLD (AU)

(72) Inventors: John Scott, St. Lucia (AU); Paul Hannah, The Dawn (AU)

(21) Appl. No.: 16/494,924

(22) PCT Filed: Mar. 17, 2017
(86) PCT No.: PCT/AU2017/050244

§ 371 Date: Sep. 17, 2019

(51) Int. Cl. G01M 15/14; G01H 11/06

(52) U.S. Cl. CPC G01M 15/14; G01H 11/06

(57) ABSTRACT

A monitoring system for monitoring a machine, the monitoring system including at least one monitoring device and one or more processing systems. The monitoring device includes a housing, a coupling that physically attaches the housing to the machine, a plurality of sensors, the plurality of sensors including a vibration sensor that senses vibration transmitted from the machine to the vibration sensor at least in part via the coupling, a monitoring device processor that acquires sensors signals from the plurality of sensors and generates sensor data at least partially in accordance with signals from the sensors, and a transmitter that transmits the sensor data. The one or more processing systems receive the sensor data, analyse the sensor data to determine a machine status and either store an indication of the machine status as part of machine status data associated with respective machine or cause a status indication indicative of the machine status to be displayed.

### BACKGROUND OF THE INVENTION

The present invention relates to a method and apparatus for machine monitoring, and in one example to a method and apparatus using a monitoring device that physically attaches to the machine.

### DESCRIPTION OF THE PRIOR ART

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

Monitoring of machines, such as pumps is often performed in order to monitor operation, and in particular to ensure the machine is operating correctly and has not failed. Such monitoring is typically performed on an ad-hoc basis through a process of visual inspections and routine maintenance. However, this is not always a practical solution. For example, the water industry within the Australian context suffers from the ‘tyranny of distance’, in which a machine is generally spread across broad geographic expanses. As a result, Sydney Water undertakes over 10,000 manual machine inspections for machine condition monitoring. Manual inspections are therefore costly, time consuming and irregular.

Assets are generally classified into a tiered system, where low value/low impact machines are considered uneconomical to conduct condition monitoring. The next class of assets are regularly inspected (typically monthly), and finally high value/high impact machinery where ‘online’ monitoring or real time monitoring is installed (this is typically the top 5% of machinery). In such situations, custom sensor suites are developed and installed for each machine, with alerts being sent once a day. Such systems typically cost several thousand dollars per machine, with the largest costs being the installation and setup which has to be conducted by a trained engineer. These systems require permits, paperwork and cabling.

### SUMMARY OF THE PRESENT INVENTION

In one broad form, an aspect of the present invention seeks to provide a monitoring system for monitoring a machine, the monitoring system including: at least one monitoring device including: a housing; a coupling that physically attaches the housing to the machine; a plurality of sensors, the plurality of sensors including a vibration sensor that senses vibration transmitted from the machine to the vibration sensor at least in part via the coupling; a monitoring device processor that: acquires sensor signals from the plurality of sensors; and, generates sensor data at least partially in accordance with signals from the sensors; a transmitter that transmits the sensor data; and, one or more processing systems that: receive the sensor data; analyse the sensor data to determine a machine status; and, at least one of: store an indication of the machine status as part of machine status data associated with the respective machine; and cause a status indication indicative of the machine status to be displayed.

In one embodiment, the vibration sensor includes a microphone acoustically coupled to the machine at least in part via a rigid mechanical coupling member.

In one embodiment, the microphone is provided adjacent a first end of a cavity and the rigid coupling member includes a projection extending from the housing to a second end of the cavity, to thereby couple vibrations to the microphone via the cavity.

In one embodiment, the cavity is an opening provided in a circuit board, the microphone being mounted on the circuit board.

In one embodiment, the microphone is a microelectromechanical microphone provided in a housing having an opening facing the cavity.

In one embodiment, the projection includes: an isolation member in abutment with the circuit board to isolate the cavity from external noise; and, a flattened tip extending into the cavity, such that movement of the tip generates pressure fluctuations within the cavity, the pressure fluctuations corresponding to the vibrations.

In one embodiment, at least one of a microphone housing and the cavity are filled with an acoustic gel.

In one embodiment, the housing includes: a base; and, a cap coupled to the base.

In one embodiment, the housing includes a sealing member positioned between the base and the cap, so that the base and the cap sealingly engage.

In one embodiment, the housing includes a channel extending around a perimeter of the base, the sealing member being positioned in the channel, and the cap including a lip shaped to conform with the channel and engage the seal.

In one embodiment, the coupling includes a magnet fixed to the housing.

In one embodiment, the coupling includes a cup containing the magnet so that the cup engages the machine to thereby transmit vibrations from the machine to the housing.

In one embodiment, the coupling includes a number of teeth that engage the machine in use to thereby at least one of: assist in securing the monitoring device to the machine; and, assist in transmitting vibrations from the machine to the monitoring device housing.

In one embodiment, the coupling includes a surface shaped to conform to an outer surface of the machine to thereby at least one of: assist in securing the monitoring device to the machine; and, assist in transmitting vibrations from the machine to the monitoring device housing.

In one embodiment, the monitoring device includes at least one power supply.

In one embodiment, the at least one power supply includes a turbine.

In one embodiment, the turbine includes: a generator; a rotor positioned externally to the housing and coupled to the generator; and, a plurality of rotor blades mounted on the rotor and extending axially along and radially outwardly of an outer cylindrical surface of the housing such that gaseous flow over the vanes rotates the rotor, thereby causing the generator to generate power.

In one embodiment, the sensor data includes at least one of: a monitoring device identifier; signals from the sensors; and, one or more parameters derived from signals from the sensors.

In one embodiment, the monitoring device at least partially processes the sensor signals.

In one embodiment, the monitoring device at least partially processes the sensor signals by at least one: filtering; amplifying; digitizing; and, parameterizing.

In one embodiment, the plurality of sensors include at least one of: at least one current sensor; a noise sensor; an acoustic sensor; a temperature sensor; a pressure sensor; a humidity sensor; a movement sensor; and, an optical sensor.

In one embodiment, the system: uses signals from one or more sensors during a first time period to establish reference behavior for the machine; and, uses signals from the one or more sensors and the reference behavior to determine a machine status.

In one embodiment, the system: uses signals from one or more sensors to generate reference data indicative of the reference behavior, the reference data being indicative of at least one of: signals from the one or more sensors; parameters derived from signals from the one or more sensors; patterns derived from signals from the one or more sensors; reference thresholds derived from the signals from the one or more sensors; and, reference ranges derived from the signals from the one or more sensors; and, determines a machine status at least in part based on the reference data and signals from the one or more sensors.

In one embodiment, the system: determines operational data using signals from the one or more sensors, the operational data being based on at least one of: signals from the one or more sensors; parameters derived from signals from the one or more sensors; and, patterns derived from signals from the one or more sensors; and, compares the operational data to the reference data.

In one embodiment, the parameters include at least one of: a noise level; a noise frequency; a temperature; a temperature change; a rate of temperature change; a vibration frequency; a vibration magnitude; a vibration pattern; a vibration change; and, a rate of vibration change.

In one embodiment, the system assesses the machine status at least in part using machine learning techniques.

In one embodiment, the system uses machine learning techniques to: identify at least one category of behavior for the machine from the reference behavior; and, determine the machine status by analyzing signals from the one or more sensors to categorize a current behavior based on the at least one category.

In one embodiment, the system analyses signals from the one or more sensors with respect to reference behavior determined during corresponding time intervals during which the machine is expected to exhibit similar behavior.

In one embodiment, the system: monitors changes in machine status over time; and, at least one of: stores an indication of changes in machine status as part of machine status data associated with respective machine; cause a status indication indicative of the change in machine status to be displayed.

In one embodiment, the system: uses signals from one or more sensors during a calibration time period when the monitoring device is attached to a calibration machine to establish calibration data; and, using the calibration data to interpret signals from the sensors when the monitoring device is attached to the machine.

In one embodiment, the one or more processing systems: determine an identifier of the monitoring device; uses the identifier to retrieve calibration data; and, analyse the sensor data at least in part using the calibration data.

In one embodiment, the system: analyses signals from the vibration and movement sensors; and, uses signals from the movement sensor to dynamically calibrate the vibration sensor.

In one embodiment, the system: determines a monitoring device integrity; and, selectively generates an alert depending on results of the determination.

In one embodiment, the system: analyses signals from a humidity sensor to determine changes in humidity within the housing; and, using changes in humidity to determine at least one of: if the housing has been breached; and, if a housing seal has failed.

In one embodiment, the housing contains a desiccant.

In one embodiment, the system: analyses signals from a light sensor to determine changes in light levels within the housing; and, using changes in light levels to determine at least one of: if the housing has been breached; and, if a housing seal has failed.

In one embodiment, the system determines if the monitoring device has been moved by: analysing signals from a movement sensor to determine at least one of: movement; and, a change in orientation; analysing signals from a microphone to determine a change in noise levels; and, determine a wireless network signal strength to determine a change in position of the transmitter relative to a receiver.

In one embodiment, the monitoring device includes an array of current sensors mounted on a flexible substrate external of the housing, and wherein the flexible substrate is adapted to be wound around a cable to thereby monitor current flows within the cable.

In one embodiment, the monitoring device includes a transducer for generating an acoustic signal that is transmitted to the machine at least in part via the coupling to thereby generate vibrations that can be detected by a monitoring device.

In one embodiment, the acoustic signal has a defined frequency to allow the acoustic signal to be distinguished from vibrations of the machine.

In one embodiment, the acoustic signal is ultrasonic.

In one embodiment, the system includes two monitoring devices spaced apart along a fluid pipe, and wherein the system monitors a speed of travel of the acoustic signal between the two monitoring devices to thereby determine a flow of fluid within the pipe.

In one embodiment, the system: analyses signals from an acoustic sensor to determine changes in noise levels outside the housing; and, using changes in noise levels to determine at least one of: changes in operation of remote machines; changes in a machine environment; movement of the monitoring device; changes in operation of the monitoring device; and, if the housing has been breached.

In one embodiment, the acoustic sensor is mounted in recess on an external surface of the housing.

In one embodiment, the system includes at least one hub that: receives sensor data from a plurality of monitoring devices; and, transfers the sensor data to the one or more processing devices via a communications network.

In one embodiment, the hub and monitoring devices communicate using a short range wireless communications protocol.

In one broad form, an aspect of the present invention seeks to provide a monitoring device for use in monitoring a machine, the monitoring device including: a housing; a coupling that physically attaches the housing to the machine; a plurality of sensors, the plurality of sensors including a vibration sensor that senses vibration of the machine transmitted to the vibration sensor at least in part via the coupling; monitoring device processor that generates sensor data in accordance with signals from the sensors; and, a transmitter that transmits the sensor data, allowing the sensor data to be transferred via a communications network.

In one broad form, an aspect of the present invention seeks to provide a method for monitoring a machine, the method including: receiving sensor data from a monitoring device attached to the machine, the sensor data being generated at least in part based on signals from a plurality of sensors, the plurality of sensors including a vibration sensor that senses vibration of the machine transmitted to the monitoring device via a coupling; analysing the sensor data to determine a machine status; and, at least one of: store an indication of the machine status; and, cause an indication of a machine status to be displayed.

In one embodiment, the method includes: using signals from one or more sensors to generate reference data indicative of the reference behavior, the reference data being indicative of at least one of: signals from the one or more sensors; parameters derived from signals from the one or more sensors; patterns derived from signals from the one or more sensors; reference thresholds derived from the signals from the one or more sensors; and, reference ranges derived from the signals from the one or more sensors; and, determining a machine status at least in part based on the reference data and signals from the one or more sensors.

In one embodiment, the method includes: determining operational data using signals from the one or more sensors, the operational data being based on at least one of: signals from the one or more sensors; parameters derived from signals from the one or more sensors; and, patterns derived from signals from the one or more sensors; and, comparing the operational data to the reference data.

In one embodiment, the parameters include at least one of: a noise level; a noise frequency; a temperature; a temperature change; a rate of temperature change; a vibration frequency; a vibration magnitude; a vibration pattern; a vibration change; and, a rate of vibration change.

In one embodiment, the method includes assessing the machine status at least in part using machine learning techniques.

In one embodiment, the method includes using machine learning techniques to: identify at least one category of behavior for the machine from the reference behavior; and, determine the machine status by analyzing signals from the one or more sensors to categorize a current behavior based on the at least one category.

In one embodiment, the method includes analysing signals from the one or more sensors with respect to reference behavior determined during corresponding time intervals during which the machine is expected to exhibit similar behavior.

In one embodiment, the method includes: monitoring changes in machine status over time; and, at least one of: storing an indication of changes in machine status as part of machine status data associated with respective machine; causing a status indication indicative of the change in machine status to be displayed.

In one broad form, an aspect of the present invention seeks to provide a method for filling a microphone housing with acoustic gel, the method including: providing at least one microphone housing containing a microphone in a vacuum chamber; progressively removing air from the vacuum chamber; and, introducing an acoustic gel into the vacuum chamber so that the gel enters the microphone housing through a microphone housing opening.

In one embodiment, the method includes preheating the acoustic gel.

In one embodiment, the method includes removing air from the vacuum chamber until the vacuum chamber reaches a predetermined pressure, and wherein the pressure is at least one of: less than 50 kPa; less than 10 kPa; less than 5 kPa; less than 1 kPa; and, less than 0.1 kPa.

In one embodiment, microphone is a microelectromechanical microphone.

In one embodiment, acoustic gel is at least one of: a temperature resistant gel; and, a room temperature vulcanization silicone gel.

In one embodiment, microphone is mounted on a circuit board with the microphone housing opening adjacent a circuit board opening so that the circuit board opening fills with acoustic gel.

It will be appreciated that the broad forms of the invention, and their respective features can be used in conjunction, interchangeably and/or independently, and reference to separate broad forms is not intended to be limiting.

### BRIEF DESCRIPTION OF THE DRAWINGS

An example of the present invention will now be described with reference to the accompanying drawings, in which: —

FIG. 1 is a schematic diagram of an example of a system for monitoring a machine;

FIG. 2 is a flow chart of an example of a process for monitoring a machine;

FIG. 3 is a schematic diagram of a second example of a system for monitoring a machine;

FIG. 4 is a schematic diagram of a processing system of FIG. 3;

FIG. 5 is a schematic diagram of an example of a client device of FIG. 3;

FIG. 6A is a schematic cutaway view of an example of a monitoring device housing;

FIG. 6B is a schematic close up view of the vibration sensor of FIG. 6A;

FIG. 6C is a schematic cutaway view of a further example of a monitoring device housing;

FIG. 6D is a schematic underside view of the monitoring device housing of FIG. 6D;

FIG. 6E is a schematic diagram of an example of a separate turbine housing;

FIGS. 7A and 7B are a flow chart of an example of a process for monitoring a machine;

FIG. 8A is a schematic diagram of a first example of a screen shot for use in monitoring a machine;

FIG. 8B is a schematic diagram of a second example of a screen shot for monitoring a machine;

FIG. 9 is a flow chart of an example of a process for establishing reference data; and,

FIG. 10 is a flow chart of an example of a process for analysing sensor signals.

### DETAILED DESCRIPTION OF THE PREFERRED EMBODIMENTS

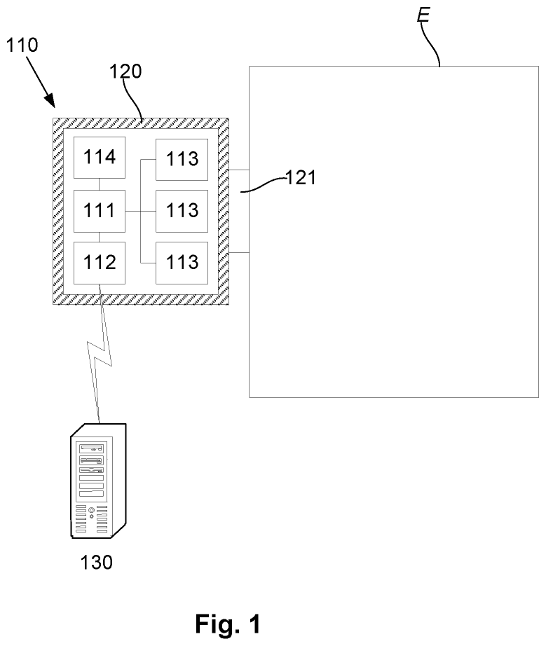

An example of a system for monitoring a machine will now be described with reference to FIG. 1.

In this example, the apparatus 100 includes a monitoring device 110 having a housing 120 and a coupling 121 that physically attaches the housing 120 to machine E that is to be monitored. In this regard, the machine can be any form of machine that requires monitoring, and which generates detectable characteristics, such as vibrations, noise, heat, or the like and examples include, but are not limited to, pumps, compressors, engines, motors or the like.

The monitoring device typically includes a plurality of sensors 113, each of which is adapted to sense one or more characteristics. Whilst any suitable sensors could be used, in general the sensors 113 include at least a vibration sensor that senses vibrations transmitted from the machine to the vibration sensor via the coupling 121. However, other sensors, such as temperature sensors, or the like, could be used as will be described in more detail below.

The monitoring device 110 also typically includes a monitoring device processor 111 and a transmitter 112, as well as an optional power supply 114, allowing the monitoring device to monitor the sensors and provide sensor data to one or more processing systems 130, for subsequent analysis. The nature of the processing systems 130 will vary depending upon preferred implementation and could include computer systems such as personal computers, laptops, desk tops, servers, mobile communication devices such as smart phones or tablets or the like. Further examples will be described in more detail below.

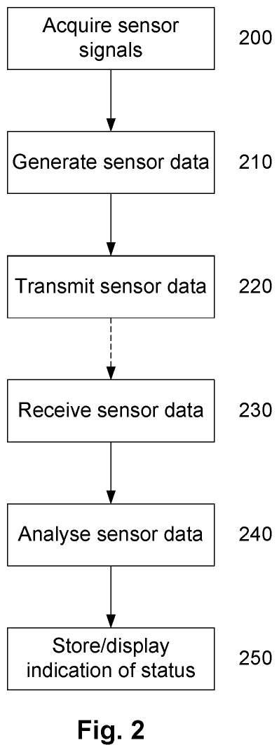

An example of a process for using the system of FIG. 1 to monitor machine will now be described with reference to FIG. 2.

In this example, at step 200 sensor signals are acquired from the plurality of sensors 113, including the vibration sensor. The sensor signals are acquired by the monitoring device processor 111 optionally after preliminary processing, such as filtering, or the like, has been performed.

At step 210 the monitoring device processor 111 generates sensor data at least partially in accordance with signals from the sensors. The sensor data could be of any appropriate form and may include an indication of the sensor signals, or information derived therefrom, such as one or more parameters obtained by analysing the sensor signals. For example, the monitoring device processor could perform preliminary analysis, such as performing a Fourier transform, providing frequency domain information instead of raw data. The sensor data may also include other information, such as an identifier used to identify the monitoring device.

At step 220, the sensor data is transmitted by the transmitter 112, allowing this to be received by the processing system(s) 130 at step 230, for example by having the sensor data transferred via a communications network, point-to-point connection, or the like.

At step 240 the processing system 130 analyses the sensor data to determine a machine status. The machine status can be of any appropriate form and may include an indication of whether the machine is functioning as expected, or if not the nature of any problem and/or could include an indication of sensor signals or parameters derived from the sensor signals and/or a result of comparison of the sensor signals or parameters to reference ranges or thresholds. For example, this could include showing a currently measured level of vibration compared to an expected level of vibration to determine whether the machine is currently operating normally.

Once a machine status has been determined, this can either be stored for example as part of machine status data forming part of a profile associated with the respective machine, or could be used to generate a status indication indicative of the machine status allowing this to be displayed to a user at step 250.

Accordingly, it will be appreciated that the above described system enables monitoring of machine to be performed. In particular, the above described system allows machine to be monitored by physically attaching a monitoring device directly to the machine. The monitoring device can incorporate multiple sensors within a single housing, allowing multiple different parameters to be monitored, whilst only requiring a single device to be fitted to the machine. In particular, this allows the monitoring device to be used to monitor vibrations of the machine, and optionally other parameters, such as a machine temperature or the like. This is achieved using a physical coupling that attaches the monitoring device to the machine, and additionally transmits the vibrations from the machine to the onboard vibration sensor. This allows a monitoring device to be easily retrofitted to existing machine, simply by coupling the monitoring device to the machine, allowing the monitoring system to monitor machine operation without interfering with the machine operation.

Sensor data indicative of the vibrations and any other measured parameters can then be transferred to one or more remote processing systems, allowing these to be analysed to ensure the machine is functioning correctly. This reduces the level of processing required by the monitoring device, allowing this to be implemented using relatively cheap and straightforward sensors and associated hardware, in turn allowing the sensors to be deployed widely without undue expense. Consequently, a number of different monitoring devices can be attached to a variety of different pieces of machine (generally referred to as assets), allowing these to be monitored centrally, making it easy for an entity to monitor a wide range of distributed assets.

This arrangement also allows data to be stored and analysed centrally. This in turn generates a repository of sensor data that can be analysed on an ongoing basis, assisting with the identification of a wide range of different machine faults.

A number of further features will now be described.

Whilst any form of vibration sensor could be used, most typical highly sensitive vibration sensors are expensive. For example, piezoelectric accelerometers provide highly accurate absolute vibration values over a wide bandwidth (˜15 khz). However, these are made in low volumes and are hand calibrated meaning they are very expensive. As an alternative, in one example, the vibration sensor includes a microphone acoustically coupled to the machine at least in part by a rigid mechanical coupling member. The use of a microphone is particularly advantageous as highly sensitive cheap reliable microphones, such as MEMS (microelectromechanical) microphones, are readily available whereas vibration sensors tend to be complex and expensive. This can therefore reduce the complexity and cost of the sensing device, whilst still providing sufficient accuracy to allow sensing to be accurately performed. Other example sensors that can be used include, but are not limited to low cost piezo electric elements, including elements from buzzers, starters from lighters, micro linear actuators, ultrasonic transducers or the like, loudspeaker voice coil, MEMS accelerometers, strain gauges mounted to a housing or device with varying resistance vs stress/strain, optical detectors using a with vibrating wire/mass, or the like.

In one example, acoustic coupling between the machine and the microphone is achieved in part by having the microphone provided adjacent a first end of a cavity, with the rigid coupling member including a projection extending from the housing to a second end of the cavity. This couples vibrations to the microphone via the cavity, in particular by ensuring mechanical vibrations are translated into soundwaves within the cavity, which can then be detected by the microphone.

In one example, the cavity is an opening provided in a circuit board mounted in the monitoring device housing, with the microphone being directly mounted on the circuit board, adjacent the opening, and typically with an opening of a microphone housing facing the cavity. This provides an easy mechanism for constructing the acoustic coupling, whilst ensuring a high degree of acoustic coupling between the microphone and the housing. The cavity and/or microphone housing can also be filled with an acoustic gel, to help further increase the effectiveness of the acoustic coupling.

The acoustic gel can be provided within the microphone and/or cavity in any suitable manner. In one example, this involves providing a microphone housing containing a microphone in a vacuum chamber, progressively removing air from the vacuum chamber and then introducing an acoustic gel into the vacuum chamber so that the gel enters the microphone housing through a microphone housing opening. Removing air from the vacuum chamber allows the gel to more easily penetrate the housing through an opening, thereby ensuring filling of the housing, and in particular avoiding the creation of air pockets, which can attenuate acoustic signals being transferred to the microphone.

As part of the above process, the acoustic gel might be preheated to reduce the viscosity of the gel, thereby allowing this to enter the microphone housing more easily. This will depend on the nature of the acoustic gel, although this is typically a temperature resistant gel and in one example is a room temperature vulcanization silicone gel. Air is typically removed the vacuum chamber until the vacuum chamber reaches a predetermined pressure, such as less than 50 kPa, less than 10 kPa, less than 5 kPa, less than 1 kPa or less than 0.1 kPa, although any suitable pressure could be used. In one example, the microphone can be pre-mounted on the circuit board before being placed into the vacuum chamber, with the microphone housing opening adjacent a circuit board opening so that the circuit board opening fills with acoustic gel.

The projection can include an isolation member in abutment with the circuit board to thereby isolate the cavity from external noise which helps reduce interference. Additionally, the projection can include a flattened tip extending into the cavity such that movement of the tip generates pressure fluctuations within the cavity the pressure fluctuations corresponding to the vibrations, and leading to the sound waves which are detected by the microphone.

In some instances, the degree of acoustic coupling can be controlled by appropriate configuration of the housing. For example, the housing can include features adapted to attenuate or limit vibrations, to thereby avoid saturation of the microphone. The features can include the presence of sound/vibration absorbing materials integrated into the housing and/or the rigid coupling member, or could include shaping of the housing or rigid coupling member. For example, providing apertures within the housing or coupling member can absorb vibrations, reducing the magnitude of vibrations being coupled to the microphone.

The monitoring device housing can be of any appropriate form but in one example includes a base and a cap coupled to the base. Components, such as the circuit board can be mounted to the cap, with the base being subsequently attached to the cap to thereby facilitate construction. In this regard, a sealing member is typically positioned between the cap and the base so that the base and cap are sealingly engaged, thereby preventing ingress of fluids, including liquids or gasses, which could damage the sensors, as well as reducing ambient noise when level within the sensors to thereby increase the accuracy of the vibration sensing.

Whilst the monitoring device could be coupled to the machine in any suitable manner, such as by using a mounting bracket or similar, in one example, the coupling includes a magnet fixed to the housing, allowing the housing to be magnetically coupled to the machine. This provides a mechanism to easily attach the monitoring device without requiring specific tools, and without requiring adaptation of the machine, whilst still providing a sufficiently strong coupling to prevent dislodgement of the monitoring device and to ensure vibrations are transmitted through the coupling to the vibration sensor. As a result of this arrangement in the majority of cases the monitoring device can simply be placed in contact with the machine, without requiring the machine to be stopped to allow mounting of the monitoring device, as might be required with other attachment techniques, such as bolting or the like. Additionally, in some cases equipment is relatively inaccessible, meaning that attachment of a monitoring device could be difficult. However, the use of a magnetic coupling can overcome many of these difficulties, allowing the monitoring device to be moved into a position close to the machine, with the magnetic coupling then attaching the monitoring device. For example, if located in a pit, the monitoring device could be lowered on a rope and swung towards the machine, allowing the monitoring device to attach to the machine. This can avoid problems associated with accessing machinery in enclosed environments, such as the need for to follow particular safety protocols or the like.

In one example, the coupling can include a cup containing the magnet, with the cup being attached to the base and upturned so that a rim of the cup engages the machine, thereby transmitting vibrations from the machine to the housing, via the cup body. This can help ensure vibrations are transferred from the machine to the base and hence to the vibration sensor with minimal attenuation, whilst also helping reduce the transmission of excessive forces to the magnet, which could in turn lead to degradation of the magnet, thereby reducing the effectiveness of the coupling.

To further facilitate attachment of the monitoring device, the coupling includes a number of teeth that engage the machine in use to thereby assist in securing the monitoring device to the machine and/or assist in transmitting vibrations from the machine to the monitoring device housing. For example, teeth can be provided around a rim of the cup, so that the teeth contact the surface of the machine. This can cut through paint, grease or other materials present on the machine surface, helping to ensure direct physical contact between the monitoring device and the machine, which in turn helps optimise transmission of vibrations to the monitoring device. This can also assist in ensuring that the monitoring device grips the surface of the machine, reducing the likelihood of the monitoring device slipping off the surface after attachment.

The coupling can also include a surface shaped to conform to an outer surface of the machine, with this again being used to assist in securing the monitoring device to the machine and/or assist in transmitting vibrations from the machine to the monitoring device housing. For example, if the machine has a curved convex outer surface, the coupling could include a corresponding concave shape so that there is physical contact between the shaped surface and the machine over substantially the entirety of the coupling surface. Such an arrangement could be achieved through suitable shaping of the monitoring device, such as providing a shaped cup, but more typically is achieved through the use of adapter plates. Such an adapter plate can sit between the cup and the machine surface, with a range of different adapter plate shapes being provided so that a respective adapter plate can be selected to conform to the corresponding to common machine surface shapes, such as curved

As previously mentioned, the monitoring device can include a power supply. The power supply could be in the form of a battery or the like. In one example, first and second power supplies can be provided, with one operating to power to the sensors/processing device/transmitter in normal use and another acting to provide ancillary power, for example to power volatile memory in the event of failure of the first power supply. However, this is not essential and any suitable arrangement could be used.

In a further example, the power supply can be adapted to generate power based on available ambient sources. For example, the power supply could include solar panels adapted to generate electricity from ambient solar radiation, or could be adapted to generate electricity based on vibrations of the machine. In a further preferred example, the power supply could include a turbine adapted to generate power from ambient gas/airflow, such as exhaust gas flow from the machine. In this example, the turbine typically includes a generator mounted in the housing and a rotor and rotor blades mounted externally to the housing. In one particular example, the housing is a substantially cylindrical housing, with the rotor blades extending in an axial direction and positioned radially outwardly from an outer circumferential surface of the housing so that such that gaseous flow over the blades the causes the blades to rotate around the housing, thereby rotating the rotator and in turn causing the generator to generate power.

As mentioned above, the monitoring device typically includes a plurality of sensors. The plurality of sensors could include any one or more of a noise sensor, an acoustic sensor, a temperature sensor, a pressure sensor, a humidity sensor, a movement sensor and an optical sensor. It will be appreciated from this that a range of different parameters regarding machine operation can be monitored depending on the preferred implementation. The sensors can also be adapted to ensure integrity of the monitoring device, as will be described in more detail below.

Analysis of the sensor signals is typically achieved by comparing the sensor signals to reference behaviour of the machine, which is usually at least partially indicative of normal operation of the machine. In this regard, as each piece of machine typically behaves in a unique way, depending on the configuration of the machine and the manner in which it is used, the system typically uses signals from one or more sensors during a first time period to establish reference behaviour, then using signals from the one or more sensors outside this first time period, together with the reference behaviour, to determine a machine status.

Thus, this approach allows normal behaviour for the machine to be monitored, allowing this to be used in establishing reference behaviour. The system can then analyse current operation of the machine by comparing signals from the one or more sensors to signals collected while the machine is operating normally in order to assess the current operational status of the machine. Thus deviation of the signals from those collected during the first time period can be indicative of abnormal behaviour, which is in turn indicative of a potential problem. For example, if signals from the sensors do not exceed certain threshold values during the first time period, then if signals exceed these threshold values during monitored operation, this could be indicative of a problem that requires maintenance or additional investigation.

This approach of analysing machine during a reference time period and using this to establish reference behaviour allows monitoring of machine to be performed with no prior knowledge of the particular machine which is being monitored. In particular, this avoids the need to perform a complex analysis of machine operation to understand machine behaviour, instead establishing sensor readings associated with reference behaviour and then analysing current sensor readings to identify deviations from the reference behaviour.

In one example, this analysis is performed by generating reference data indicative of the reference behaviour, and then determining a machine status at least in part based on the reference data and signals from the one or more sensors, for example by generating operational data using signals from the one or more sensors and then comparing this to the reference data.

Whilst reference and operational data in the form of sensor signals can be compared directly, more typically signals from one or more sensors are used to determine parameters indicative of machine operation with the parameters being used to determine the machine status. The parameters can include any one or more of noise level, noise frequency, a temperature, a temperature change, a rate of temperature change, a vibration frequency, a vibration magnitude, a vibration pattern, a vibration change and a rate of vibration change. It will also be appreciated that other parameters could be determined depending upon the nature of the machine and the preferred implementation.

Additionally and/or alternatively, the reference and/or operational data could be based on patterns derived from signals from the one or more sensors, for example examining particular sequences of signal or parameter values. For example a particular sequence of vibrations might occur during pump start-up, so presence of that pattern in signals being analysed indicates that the pump is starting up. It should be noted in this regard that the system does not need to understand that this pattern of signals means the pump is starting up, but merely needs to identify that this is normal behaviour, and hence that the pump is operating correctly when the pattern is detected.

Additionally, the reference data could include thresholds or reference ranges derived from the signals from the one or more sensors, for example based on average and standard deviation ranges of signals measured during the reference time period. This can be used to define absolute values of sensor readings that are expected in normal use, so that readings exceeding these values are indicative of abnormal behaviour.

In a preferred example, the system assesses the machine status at least in part using machine learning techniques. This is particularly beneficial as this allows the system to learn different operational behaviours of the machine over time, which in turn allows the monitoring system to be used with a wide range of different types of machine, without undergoing a separate analysis of the machine to assess possible failure modes.

Whilst any form of machine learning techniques could be used, in one example, the system uses machine learning techniques to identify at least one category of behavior for the machine from the reference behavior and then determines the machine status by analyzing signals from the one or more sensors to categorize a current behavior based on the at least one category. For example, the machine learning technique could identify signal ranges or patterns corresponding to normal behaviour. If the measured signals then deviate from these ranges or patterns, this allows operation to be classified as abnormal. In one example, a degree of deviation of the signals could be used to define a degree of any issues. For example, if sensor readings fall within a single standard deviation of normal values, this could indicate minor problems, whereas signals beyond a single standard deviation could indicate more serious problems. Similarly, by defining multiple categories, this in turn allows multiple different classifications to be established, such as a range extending from “healthy” to “moderate” and then to “serious”.

It will be appreciated that the machine learning process can be aided by feedback from users. For example, if an event is classified as a serious problem, and it is later confirmed that this was in fact normal operation, this information can be fed back into the machine learning process, allowing the system to reclassify behaviours and more accurately identify issues moving forward.

In one example, the system can be adapted to compare reference and operational data determined during corresponding time intervals during which the machine is expected to exhibit similar behaviour. For example, a pump in a pumping facility may be adapted to operate at different pumping levels during different times of the day, for example starting up at 7 am, operating at an intermediate capacity until midday and then operating at maximum capacity until 5 pm. Accordingly, the machine learning approach can identify these patterns and then analyse reference and operational data at similar times of the day to ensure that operational data is compared to reference data collected when the pump is exhibiting similar behaviours.

In addition to monitoring a static current operational status, the system can also be adapted to perform longitudinal monitoring, in which changes in machine status over time are examined to determine a rate of change of operational state. An indication of this can then be stored as part of machine status data associated with respective machine and/or displayed to a user. This allows a user to assess not only a current status, but how the status is changing over time, for example to assess if changes are rapid or slow, in turn allowing the user to determine a likely point of failure and how urgent is the need for maintenance.

In addition to comparing data collected during a first time period with operational data collected during second time period, the sensor can also undergo a calibration process. In this example, calibration data can be established while the monitoring device is attached to calibration equipment. The calibration data can then be used to interpret signals from the sensor when the monitoring device is attached to the machine. In this example, when sensor data is to be analysed it is typical to determine an identifier of the monitoring device, use the identifier to retrieve calibration data and then analyse the sensor data at least in part using the calibration data. Whilst it will be appreciated that calibration is not strictly required if the same monitoring device is used on the same machine at all times, the use of calibration data can assist in allowing reference data established using one monitoring device to be utilised in analysing signals from a second different monitoring device for example if the first fails. This can also assist in counting for variations such as to account for sensor drift or the like.

In addition to, or as an alternative to calibrating the monitoring device during a calibration process, ongoing calibration can be performed, for example by comparing the output of similar sensors. In this regard, a cheap onboard motion sensor could be used to dynamically calibrate a vibration sensor, ensuring that sensor drift does not distort measured vibrations, resulting in inaccurate readings. To achieve this, vibrations measured by the vibration sensor could be compared to vibrations measured using a movement sensor, with divergence between readings over time being used to scale readings from the vibration sensor.

In addition to monitoring the machine, the system can also be adapted to monitor the monitoring device and in particular determine a monitoring device integrity. In this regard, the integrity could include a physical integrity of the monitoring device, for example to determine if the monitoring device housing has been breached, or examining if the monitoring device has been moved and is therefore no longer positioned on the machine, or is in a different position on the machine, which could in turn impact on the vibrations and other parameters sensed by the monitoring device. In this instance, the system can be adapted to selectively generate an alert if the integrity of the monitoring device has been affected, alerting users to the fact that the monitoring device requires checking and that in the intervening time, sensor data from the monitoring device may not be accurate.

A variety of different mechanisms can be used to verify the monitoring device integrity. Analysing signals from a humidity sensor can be used to determine changes in humidity within the housing, which can indicate if the housing has been breached or if the seal has failed. For example, a rapid change in humidity is likely to indicate the housing has been opened, whilst a slow change could indicate the seal has failed. To assist with this determination, the housing can contain a desiccant to ensure humidity in the housing is minimised and hence constant when the housing is sealed.

Similarly, the system can be adapted to analyse signals from a light sensor to determine changes in light levels within the housing, using changes in light levels to determine if the housing has been opened. It will be appreciated that these indications can be analysed in conjunction, for example, if the humidity increases but the light levels remain the same it is likely that the seal has failed but the housing itself has not been opened.

The system can also determine if the monitoring device has been moved by analysing signals from a movement sensor to identify a movement of or a change in orientation of the monitoring device. Similarly, analysing signals from a microphone could be used to determine a change in noise levels, in turn signify the monitoring device has been moved, whilst a wireless network signal strength could be used to determine a change in position of the transmitter relative to a receiver.

The monitoring device can also include one or more sensors provided external to the housing. For example, the monitoring device can include an array of current sensors mounted on a flexible substrate external of the housing, with the substrate being adapted to be wound around a cable to thereby allow current flows within the cable to be monitored. In this case, the flexible substrate is typically electrically connected to the monitoring device via a cable extending from the housing, although alternatively wireless connections could be used. It will be appreciated that this extends the range of sensing capabilities of the monitoring device.

In the above described arrangement, the monitoring device operation is substantially passive in the sense that it is simply detecting operational characteristics of the machine based on physical attributes of machine operation. However, this is not essential and additionally and/or alternatively active sensing can be performed by having the machine interact with the machine in some manner.

In one example, this is achieved by having the monitoring device include a transducer for generating an acoustic signal that is transmitted to the machine at least in part via the coupling to thereby generate vibrations that can be detected by a monitoring device. In this instance, monitoring the induced vibrations can be used to determine more information that would otherwise be the case. For example, this can be used to assess the machine state when the machine is not otherwise operational.

Typically the acoustic signal has a defined frequency to allow the acoustic signal to be distinguished from operational vibrations of the machine. In one particular example, the acoustic signal is ultrasonic, but it will be appreciated that this is not essential and other frequencies could be used.

In one specific example, this can be used to monitor the flow of fluid within a pipe. In this example, the system includes two monitoring devices spaced apart along a fluid pipe, with a speed of travel of the acoustic signal between the two monitoring devices being used to determine a flow of fluid within the pipe. In this regard, it will be appreciated that transmission of the signal will be influenced depending on the rate of fluid in the pipe and accordingly analysing changes in the signal can be used to identify changes in fluid flow. It will be appreciated that to achieve this functionality, it may be necessary to ensure operation of the two monitoring devices are synchronised, which can be achieved by having the monitoring devices communicate, by using synchronised clocks, or the like.

In another example, the system can be adapted to analyse signals from an acoustic sensor to determine changes in noise levels outside the housing. This can be done either using a sensor attached to an outside of the housing, or by using different sensors within the housing and using signal processing to determine noise levels outside the housing. In either case changes in noise levels can be used to determine changes in operation of remote machines, changes in a machine environment, movement of the monitoring device, changes in operation of the monitoring device and/or to determine if the housing has been breached. In one particular example, this can be achieved using an acoustic sensor that is mounted in a recess on an external surface of the housing, and optionally protected by a film, rubber or epoxy layer, or the like. Signals from the acoustic sensor are monitored to determine noise levels outside the housing, which are monitored to identify changes, which are in turn indicative of changes in a surrounding environment.

The sensor data transmitted by the monitoring device can include signals from sensors, or one or more parameters derived from signals from the sensors, such as signal magnitudes, frequencies or the like. In this regard, the monitoring device can be adapted to partially process the sensor signals, for example by filtering, digitizing or parameterising the sensor signals. The sensor data also typically includes a monitoring device identifier, allowing the processing system(s) to identify the monitoring device from which sensor data has been received. By associating each monitoring device with a respective piece of machine, this in turn allowing the processing system(s) to determine the machine to which the sensor data relates.

Whilst the monitoring device and processing systems(s) can communicate directly, for example via mobile phone networks, this is not essential and indirect communication could be used. In one example, the system includes at least one hub that receives sensor data from a plurality of monitoring devices and then transfers the sensor data to the one or more processing devices 130 via a communications network. This allows a number of monitoring devices to be provided in a given location, such as a respective building, with these communicating with a single central hub via short range communications protocols such as Bluetooth, WIFI or the like, or other longer range wireless communications protocols. The hub can then provide onward connectivity to a communications network for example via GPRS or other cellular communications protocol. This allows a number of devices to be provided in a location remote from the processing systems, but without requiring the ability to communication directly with the processing systems themselves, which may require more energy intensive communications, which in turn can reduce battery life.

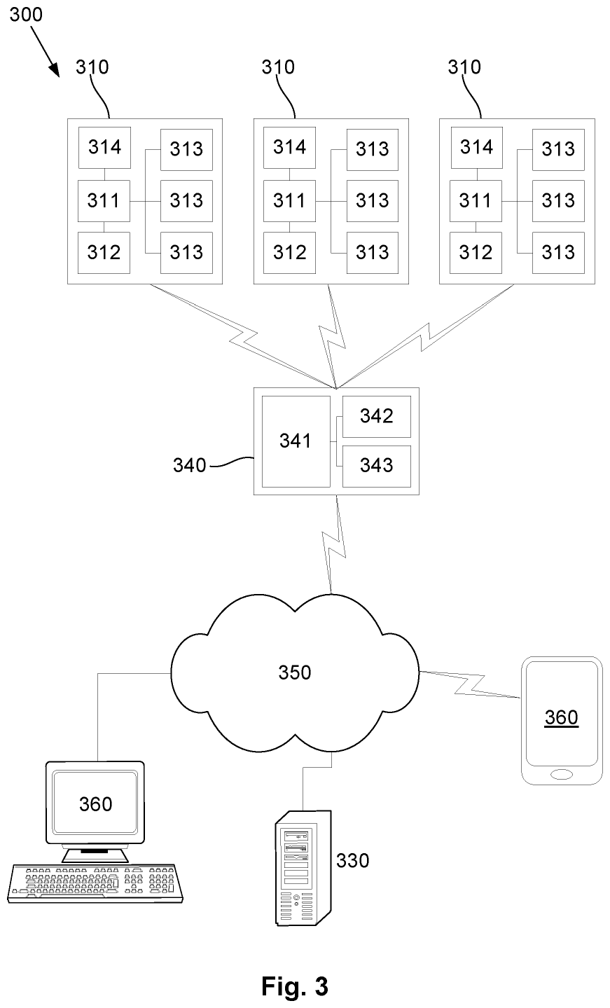

A more specific example will now be described with reference to FIGS. 3 to 6.

In this example, as shown in FIG. 3, the system 300 typically includes a number of monitoring devices 310, each of which is broadly similar to the monitoring device 110 described above, and includes a processor 311, transmitter 312, sensors 313 and power supply 314.

The system includes a hub 340, which is adapted to route sensor data from one or more of the monitoring devices 310 to a communications network 350. The hub can be of any appropriate form, but in one example includes a hub processor 341 and first and second interfaces 342, 343. The hub may also include additional components, such as memory, power supplies or the like, as will be appreciated by persons skilled in the art.

In this example, the first interface 342 is typically adapted to provide short range communications, allowing communication with one or more of the monitoring devices 310, and may include one or more Bluetooth transmitter/receiver chips, or the like. The second interface 343 is a network interface, for providing onward connectivity to one or more communications networks 350 and in one example can include a cellular communications interface, such as an integrated cellular dongle with an installed SIM card.

In use, the hub processor 341 executes instructions in the form of applications software stored in memory to allow the required processes, and in particular routing of sensor data, to be performed. Whilst the hub processor 341 can be a standard microprocessor, such as an Intel Architecture based microprocessor, this is not essential and any suitable arrangement, such as microchip processor, logic gate configuration, firmware optionally associated with implementing logic such as an FPGA (Field Programmable Gate Array), or any other electronic device, system or arrangement, could be used.

Additionally, a number of processing systems 330 are provided coupled to one or more client devices 360, via the one or more communications networks 350, such as the Internet, and/or a number of local area networks (LANs), or the like.

Any number of monitoring devices 310, hubs 340, processing systems 330 and client devices 360 could be provided, and the current representation is for the purpose of illustration only. The configuration of the networks 350 is also for the purpose of example only, and in practice the hub 340, processing systems 330 and client devices 360 can communicate via any appropriate mechanism, such as via wired or wireless connections, including, but not limited to mobile networks, private networks, such as an 802.11 networks, the Internet, LANs, WANs, or the like, as well as via direct or point-to-point connections, such as Bluetooth, or the like.

In this example, the processing systems 330 are adapted to analyse sensor data from the monitoring devices 310, and determine a machine status, providing access to the machine status and/or sensor data, allowing this to be displayed via the client devices 360. Whilst the processing systems 330 are shown as single entities, it will be appreciated they could include a number of processing systems distributed over a number of geographically separate locations, for example as part of a cloud based environment. Thus, the above described arrangements are not essential and other suitable configurations could be used.

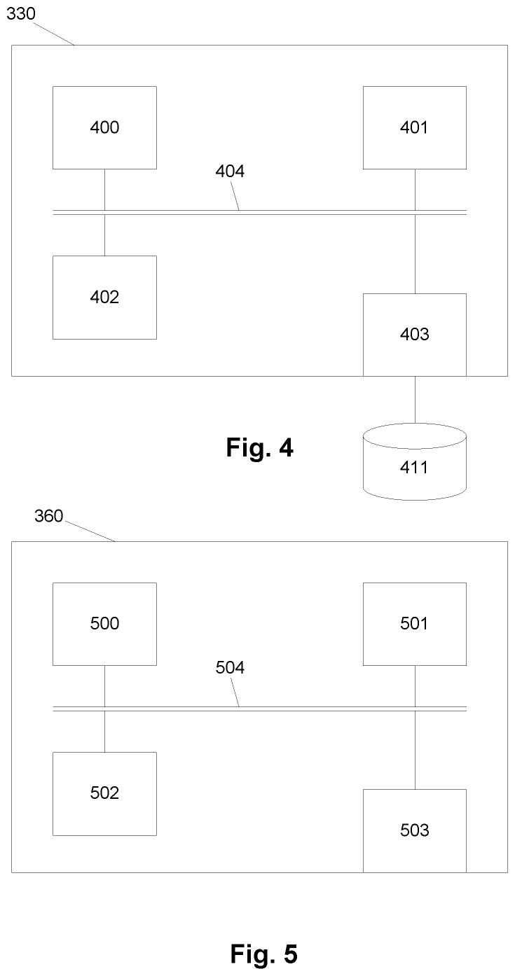

An example of a suitable processing system 330 is shown in FIG. 4. In this example, the processing system 330 includes at least one microprocessor 400, a memory 401, an optional input/output device 402, such as a keyboard and/or display, and an external interface 403, interconnected via a bus 404 as shown. In this example the external interface 403 can be utilised for connecting the processing system 330 to peripheral devices, such as the communications networks 350, databases 411, other storage devices, or the like. Although a single external interface 403 is shown, this is for the purpose of example only, and in practice multiple interfaces using various methods (eg. Ethernet, serial, USB, wireless or the like) may be provided.

In use, the microprocessor 400 executes instructions in the form of applications software stored in the memory 401 to allow the required processes to be performed. The applications software may include one or more software modules, and may be executed in a suitable execution environment, such as an operating system environment, or the like.

Accordingly, it will be appreciated that the processing system 330 may be formed from any suitable processing system, such as a suitably programmed PC, web server, network server, or the like. In one particular example, the processing system 330 is a standard processing system such as an Intel Architecture based processing system, which executes software applications stored on non-volatile (e.g., hard disk) storage, although this is not essential. However, it will also be understood that the processing system could be any electronic processing device such as a microprocessor, microchip processor, logic gate configuration, firmware optionally associated with implementing logic such as an FPGA (Field Programmable Gate Array), or any other electronic device, system or arrangement.

As shown in FIG. 5, in one example, the client device 360 includes at least one microprocessor 500, a memory 501, an input/output device 502, such as a keyboard and/or display, an external interface 503, and typically a card reader 504, interconnected via a bus 505 as shown. In this example the external interface 503 can be utilised for connecting the client device 360 to peripheral devices, such as the communications networks 350, databases, other storage devices, or the like. Although a single external interface 503 is shown, this is for the purpose of example only, and in practice multiple interfaces using various methods (eg. Ethernet, serial, USB, wireless or the like) may be provided.

In use, the microprocessor 500 executes instructions in the form of applications software stored in the memory 501, and to allow communication with one of the processing systems 330.

Accordingly, it will be appreciated that the client device 360 be formed from any suitably programmed processing system and could include suitably programmed PCs, Internet terminal, lap-top, or hand-held PC, a tablet, a smart phone, or the like. However, it will also be understood that the client device 360 can be any electronic processing device such as a microprocessor, microchip processor, logic gate configuration, firmware optionally associated with implementing logic such as an FPGA (Field Programmable Gate Array), or any other electronic device, system or arrangement.

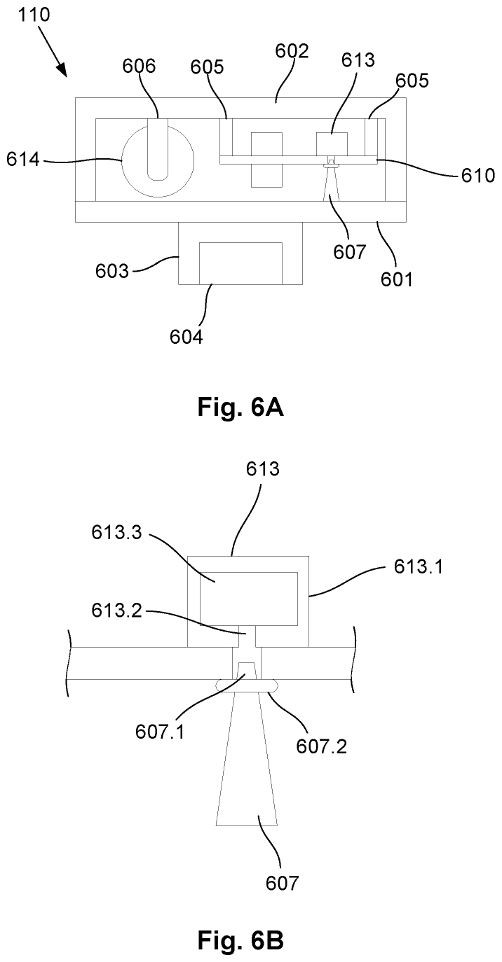

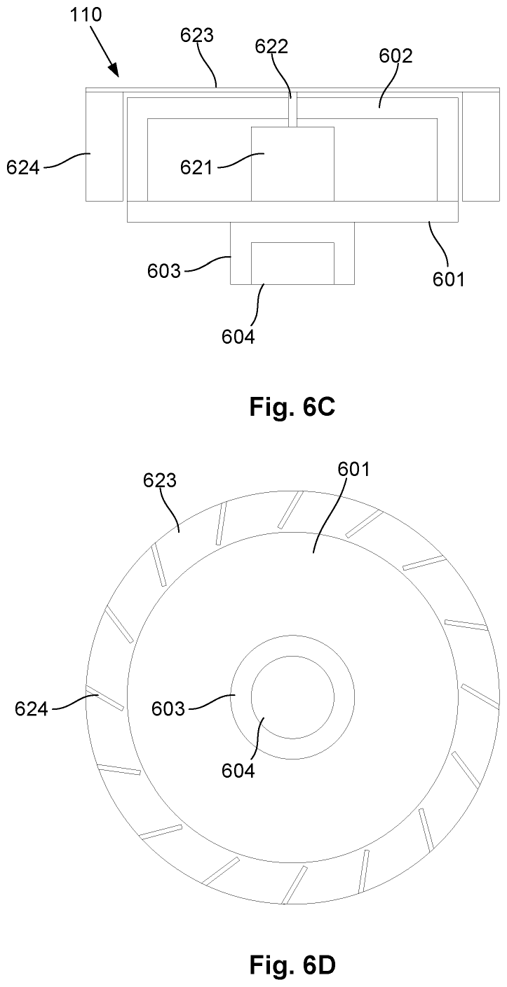

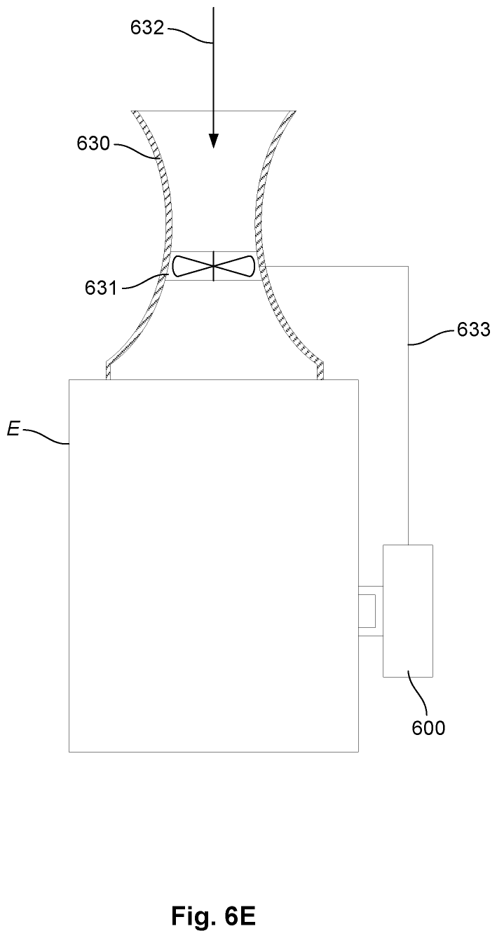

A specific example of a monitoring device 110 will now be described with reference to FIGS. 6A to 6D.

In this example, the housing includes a base 601 and a cap 602 which is coupled to the base, for example using fasteners, such as screws, an interference fit, or the like. A seal, such as an O-ring seal or similar can be provided between the cap 602 and the base 601 to thereby seal the housing. The base 601 is coupled to a metallic cup 603 containing a magnet 604 allowing the housing to be magnetically attached to machine. In particular, the rim of the cup abuts against the machine, allowing vibrations to be transmitted through the cup body to the base 601. It will be appreciated however that alternative attachment mechanisms could be used depending upon the preferred implementation.

The cap includes supports 605, 606, such as mounting tabs or clips, for supporting a printed circuit board 610 and power supply 614, such as a battery, respectively. The printed circuit board 610 supports a number of components including sensors 613 (with one being shown for illustration only), as well as the monitoring device processor, associated memory and a Bluetooth transceiver.

In the current example, the sensor 613 is a vibration sensor in the form of a MEMS microphone 613.3 provided in a microphone housing 613.1 adjacent a microphone opening 613.2, thereby allowing sound waves to enter the housing so that these can be detected by the MEMS microphone 613.3. In this example, the vibration sensor 613 is mounted directly onto the circuit board 610 adjacent a circuit board opening that forms an acoustic cavity 610.1, with the microphone opening 613.2 facing a first end of the acoustic cavity. The housing includes a projection 607 upstanding from the base 601, which includes a flattened tip 607.1 that terminates in or at least adjacent to a second end of the acoustic cavity 610.1, allowing vibrations to be coupled to the acoustic cavity, and in particular to generate sound waves within the acoustic cavity. An annular O-ring seal 607.2 is mounted on the projection and is provided in abutment with the circuit board 610 to thereby isolate the cavity from external noise.

Whilst the acoustic cavity can be air filled, in another example, the acoustic cavity is filled with an acoustic gel, to thereby optimise transfer of sound waves to the microphone 613.3. Similarly, the microphone housing 613.1 can also be filled with an acoustic gel. To achieve this, the microphone and/or circuit board can be provided in a vacuum chamber with the pressure being reduced to a defined level before gel is introduced. The gel can be a temperature resistant gel or silicone gel that cures so this can be introduced into the housing and/or cavity, with excess gel being removed before curing occurs. This ensures complete filling with gel, to ensure good transmission of acoustic signals from the projection to the microphone.

A further example housing, used with a monitoring device incorporating a turbine, is shown in FIGS. 6C and 6D.

In this example, the turbine includes a generator 621 positioned axially within a cylindrical housing, having an axle 622 extending through the cap 602. The axle is coupled to a rotor 623, which in turn has a number of rotor blades 624 extending in an axial direction and positioned radially outwardly of the housing cap 602. In use, airflow in a lateral direction relative to the housing causes movement of the blades 624 and hence rotor 623, thereby allowing power to be generated. It will be appreciated that this could be used to allow the turbine to provide power to charge a battery, and thereby extend the life of the battery 614.

In a further example, the turbine could be located separate to the housing, and an example of such an arrangement is shown in FIG. 6E.

In this example, the turbine 631 is provided in a funnel shaped housing 630, which is attached over an air inlet port of equipment E. Air drawn into the housing 630, as shown by the arrow 632, is constricted by a narrow waist, which in turn accelerates the air flow. The turbine 631 can be positioned in the housing 630, so that the air flow has a desired velocity when this reaches the turbine, to thereby optimise generation of electricity, based on typical air flow rates into the equipment E. The monitoring device 600 can then be located separately to the turbine, and electrically connected to the turbine via a suitable electrical connection 633, allowing the monitoring device to be positioned so as to maximise the effectiveness of the monitoring, whilst still ensuring electricity can be provided.

Example processes performed by the monitoring a machine will now be described in further detail. For the purpose of these examples it is assumed that one or more respective processing systems 330 are servers. In one example, the servers 330 host machine monitoring services that are accessed by the client devices 360 allowing machine to be monitored remotely. The servers 330 typically execute software, allowing relevant actions to be performed, with actions performed by the server 330 being performed by the processor 400 in accordance with instructions stored as applications software in the memory 401 and/or input commands received from a user via the I/O device 402. It will also be assumed that actions performed by the client devices 360, are performed by the processor 500 in accordance with instructions stored as applications software in the memory 501 and/or input commands received from a user via the I/O device 502.

However, it will be appreciated that the above described configuration assumed for the purpose of the following examples is not essential, and numerous other configurations may be used. It will also be appreciated that the partitioning of functionality between the different processing systems may vary, depending on the particular implementation.

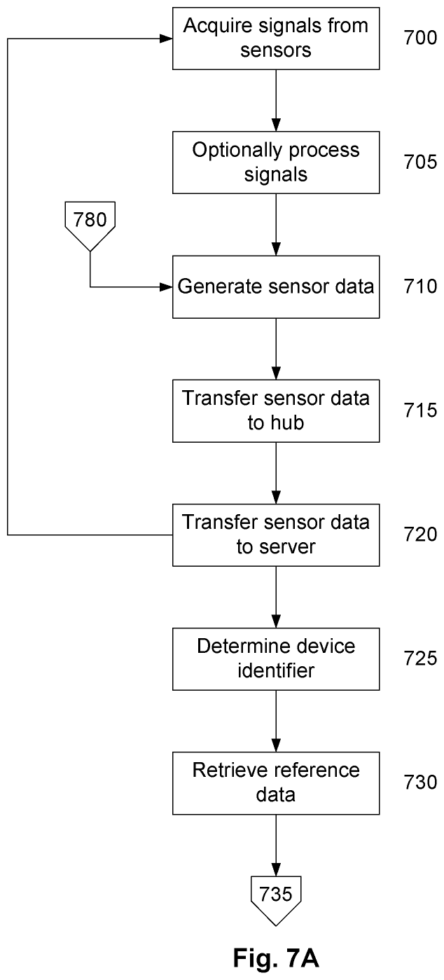

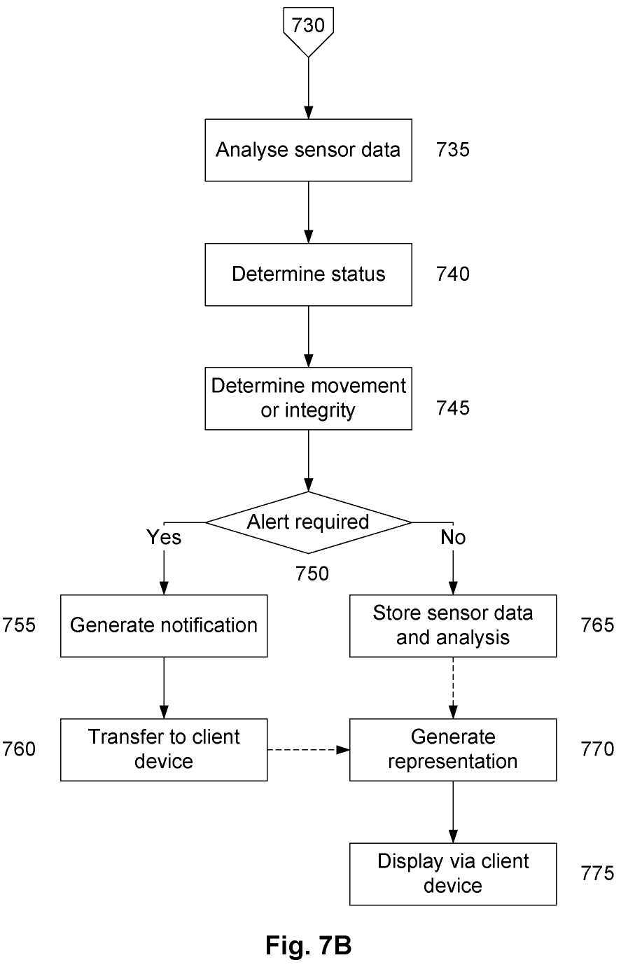

An example of a process for monitoring a machine will now be described with reference to FIGS. 7A and 7B.

In this example, signals are acquired from the sensors at step 700 with these optionally undergoing preliminary processing at step 705. The preliminary processing may be of any appropriate form, depending on the nature of the signals generated by the sensors. For example, this could include digitization of analogue sensor signals achieved using a dedicated analogue to digital convertor, and optionally filtering, amplification, or the like. This can also include performing a frequency transformation, such as a fast Fourier transform, to convert time series information into the frequency domain, which can reduce the volume of data, whilst retaining the necessary meaningful data for analysis. These can be achieved utilising known techniques and will not be described in further detail.

At step 710 the monitoring device processor 311 generates sensor data. The sensor data can be of any appropriate form and typically includes an indication of a monitoring device identifier and information derived from sensor signals. In one example, the sensor data is in the form of data packets including a data packet header containing the identifier, and a payload indicative of the sensor signals. The payload data can include raw digitised sensor signals or values derived therefrom, such as parameters, frequency domain information or the like. Typically only limited processing is performed on board the monitoring device is simple in order to reduce processing and power requirements, but it will be appreciated that this may not always be the case and indeed additional analysis may be performed in order to reduce the amount of sensor data that needs to be transmitted to the server. The data packets may also include other relevant information, such as a time or date of capture of the data.

At step 715 sensor data is transmitted to the hub 340, which routes the sensor data from multiple monitoring devices 310 to a server 330 at step 720. It will be appreciated that these steps are performed periodically, and optionally substantially continuously, depending on monitoring requirements, data transmission bandwidths or the like.

At step 725, for each data packet, the server 330 determines the device identifier associated with the received sensor data. This allows the server 330 to identify the machine to which the sensor data relates, as each piece of machine is associated with a respective monitoring device 310 during an initial set-up phase. In this regard, when the monitoring device 310 is initially attached to the machine, for example by magnetically coupling the monitoring device 310 to the machine, an installer can record an indication of the monitoring device and the machine, with this being used to establish a machine profile, which includes basic information regarding the machine, such as an indication of a machine type, identification information such as a name, serial number, or the like, a location and an indication of one or more entities responsible for the machine, such as a machine owner or operator, maintenance personnel, or the like.

The machine profile also typically includes reference data associated with the machine, as monitored by the respective monitoring device 310. The reference data can include sensor data collected during a reference time period, or information derived therefrom, such as defined ranges or thresholds of different sensor readings that correspond to normal and/or abnormal operation of the machines, as will be described in more detail below. The reference data can include different sets of reference data established during different time periods, for example to account different operation of the machine at different times of the day or week.

At step 730 the server 330 retrieves the relevant reference data, optionally taking into account the time of capture of the sensor data, using this to analyse the sensor data at step 735. The nature of the analysis will vary depending on the preferred implementation but could include comparison to either the reference data or reference ranges derived therefrom, with this being used to determine a machine status at step 740 and also to check whether the monitoring device has moved or its integrity has been in any way affected. Specific examples of the analysis will be described in more detail below, sufficed to say that upon completion of the analysis an indication of an operational status of the machine and optionally the monitoring device 310 is determined.

If a machine status is abnormal or if the monitoring device has moved or been damaged, the server 330 might determine an alert is required at step 750. In this case, at step 755, the server 330 generates a notification which can be transferred to a client device at step 760. This could include, for example, sending a text message, email or other suitable notification to a client device in accordance with contact information provided in the respective machine profile.

Otherwise sensor data and the results of the associated analysis can be stored at step 765, allowing this to be subsequently retrieved by a user using a client device 360. For example, in this instance a user may use the client device 360 to access the server 330 and request information relating to one or more assets, in which case a representation is typically generated at step 770 and displayed to the user using the client device at step 775. In this regard, it will be appreciated that the representation could be generated by the server 330 and displayed on the client device 360, for example as part of a web page or the like, or alternatively data could be transferred to the client device 360, allowing the representation to be generated locally.

In either case, the representation can be used to provide information regarding one or more assets to the user, with the user then interacting with the representation to allow further information to be displayed in an interactive manner.

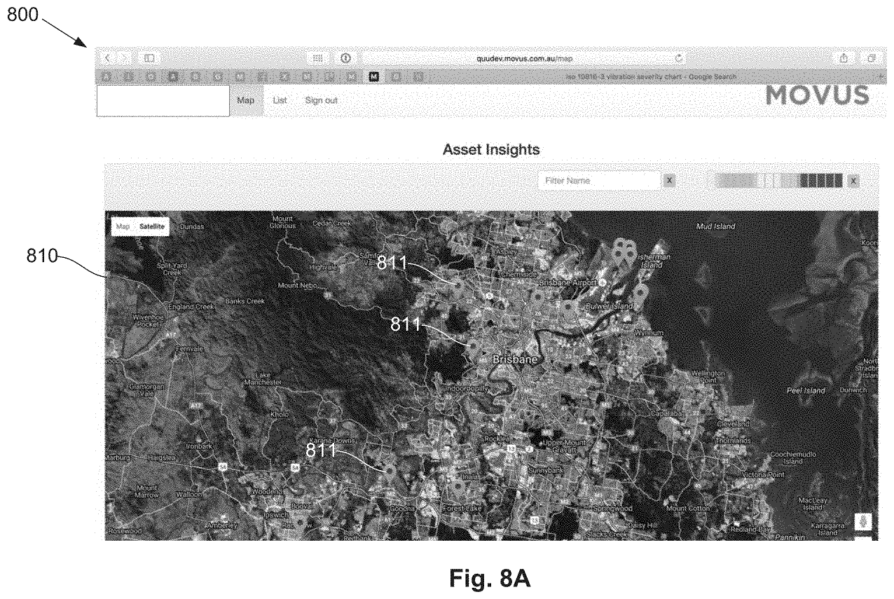

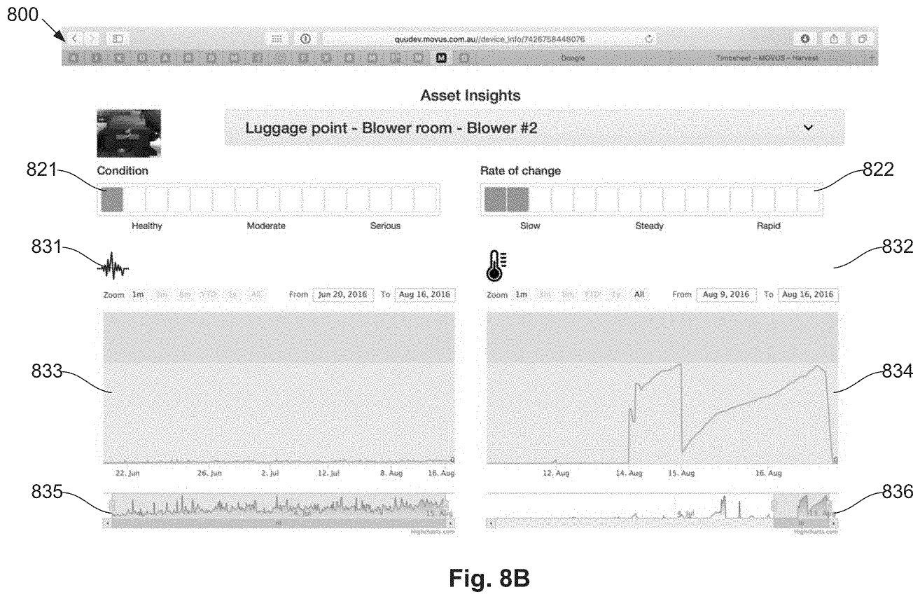

Example representations are shown in FIGS. 8A and 8B respectively.

In the example of FIG. 8A a user interface 800 is presented including a map 810, having a number of icons 811 showing the location of respective assets. The icons can be encoded to show a current asset status, for example using colours such green, amber and red to signify if the machine operation is normal, marginal, or failed or failing. The user can then interact with the representation, for example selecting a respective asset, allowing them to view further information regarding the respective asset.

In the example of FIG. 8B the status of a particular asset is shown. In this example, the user interface includes a condition indication 821 and a rate of change indication 822. The condition indication indicates whether the machine is healthy or not on a graduated scale, from “healthy” to “serious”. The rate of change indicates a rate of change of the condition, for example to show how quickly the condition is progressing from “healthy” to “serious”. This can be used by operators to determine not only the current machine condition but also how quickly this is changing allowing operators to assess a likely time of failure, or how quickly maintenance might be required.

Additionally, the user interface 800 displays a vibration and a temperature window 831, 832 which include graphs 833, 834 showing current vibration and temperature readings. Each of these graphs typically includes green, yellow and red zones indicating whether the vibrations or temperatures exceed particular defined thresholds derived from the reference data, which are in turn indicative of whether the temperature or vibration readings are indicative of a “healthy”, “moderate” or “serious” condition. Historical readings can also be selected and viewed using a respective slider 835, 836.

It will be appreciated from this that the client device 360 and server 330 cooperate to display a user interface, allowing the user to be presented with a graphical representation of status information relating to one or more assets. The user interface provides a dashboard allowing users to obtain an overview of multiple assets, and then select individual assets to review further detail, including in depth status information and representations of sensor signals.

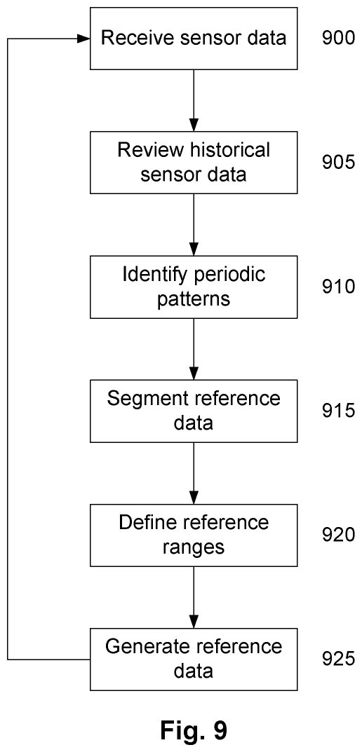

An example of the process for generating reference data will now be described with reference to FIG. 9.

In particular, sensor data is received at step 900 with this being combined with historical reference sensor data that has already been collected at step 905. The historical and current data is then analysed to determine one or more periodic patterns at step 910, for example to identify time periods when the machine is operating in a particular manner. This is used to account for the fact that the vibrations and temperature will be inherently different if the machine is operating at half power as opposed to full power, for example. This is then used to segment the data into time periods where the machine is operating in a consistent manner at step 915.

At step 920, the reference sensor data within different time periods is analysed to determine particular parameters, such as maximum, minimum or average sensor readings, rates of change of sensor readings or the like. The particular parameters that are determined will vary depending on the nature of the sensor data and the preferred implementation. These values can then be used to define reference ranges at step 925, with the reference ranges corresponding to ranges of sensor readings where the machine is operating in a “healthy”, “moderate” or “serious” condition. In this regard, information regarding the health state of the machine might need to be confirmed, with this being used as part of an analysis process in order to define boundaries of respective machine health states.

It will be appreciated that the above described processes can be performed using machine learning techniques, so that by monitoring ongoing operation of the machine, the server 330 can learn to recognise patterns of sensor readings that correspond to respective health states, allowing these states to be subsequently identified. In the event that feedback is provided regarding a health state, the server 330 can then modify the reference boundaries as required in order to ensure a determined status is correct in future. In this regard, it will be appreciated that a wide range of different machine learning techniques could be used.

Reference data embodying these reference ranges can then be stored as part of the profile associated with the respective machine at step 925.

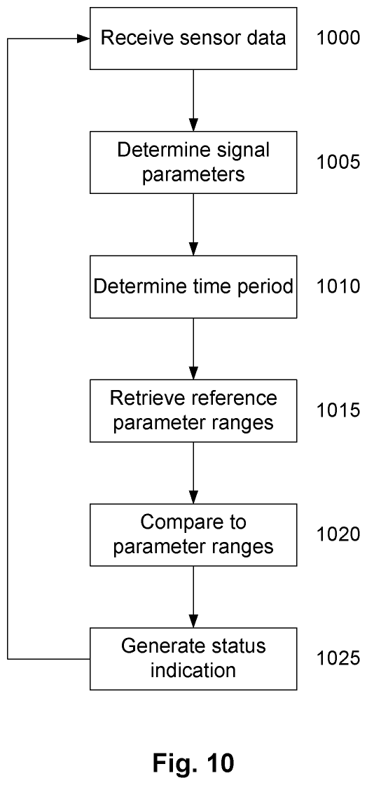

When analysing signals the process shown in FIG. 10 is used. In particular, in this example sensor data is received at step 1000 by the server 330, with this being analysed to determine signal parameters at step 1005. Again the parameters can include maximum or minimum values of sensor readings, rates of change or the like. The current time period, such as the particular time of day is determined at step 1010, allowing equivalent reference ranges to be selected at step 1015. At step 1020, the current signal parameters are then compared to the parameter ranges with this being used to determine a status indication at step 1025.

Whilst the process of generating reference data and analysing signals are shown as discrete processes, it will be appreciated that analysed signals can be used to generate further reference data, allowing ongoing training and hence refinement of the reference ranges to be performed.

It will be appreciated that this approach allows a wide range of different forms of analysis to be performed. At one level, this can include examining vibrations and/or temperatures and using this to assess operation of the machine. However, additionally, this can also involve examining humidity and/or light levels within the sensing device housing to establish if the housing has been opened, breached or the seal has otherwise failed. This can also be used to examine movement and/or changes in noise levels, in order to assess whether the monitoring device has been moved.

Accordingly, the above described system provides a sensor solution for monitoring a machine. The system combines multiple sensing capabilities into a simple, easy-to-install sensing device that can be manufactured at a highly affordable price point. The system can use machine learning and artificial intelligence algorithms to learn about the machine that it is monitoring and in turn predict impending failures.

By virtue of the fact that the above system uses generic sensing devices that can be easily attached to any machine, and that the system uses machine learning to assess when sensor readings, such as vibrations and optionally other readings such as temperature, are out of normal operating ranges, this allows the system to be set up and configured with minimal user intervention required. This in turn allows the system to be rapidly and cheaply deployed, allowing this to be offered as a monthly subscription service.

The system can avoid the need for maintenance staff to manually inspect machines on a regular (typically monthly) basis, which is costly and ineffective, as it often involves staff inspecting machines that may be working perfectly. In Australia this can involve driving large distances to remote and inaccessible locations. This can also result in staff having to access machines in dangerous and unsafe environments. Instead the current system can continuously monitor machine and provide alerts before machines need maintenance. Maintenance and operations teams are able to schedule maintenance proactively rather than operating reactively. This improves workplace safety, reduces cost, drives productivity and improves asset availability.

Thus, current maintenance practices, which involve either running machine to failure or periodic inspections (typically once a month or yearly) can be avoided. Instead providing continuous low cost monitoring avoids the need for inspections, massively reducing maintenance costs. In one example, the system achieves this by monitoring vibration and/or temperature to detect when a machine is degrading towards failure and alert maintenance staff to action. Therefore maintenance activities are targeted towards machinery that requires action, not machines that are working perfectly.

In one example, access to information regarding multiple assets can be provided via a single user interface acting as a dashboard to provide an overview of operation of individual assets. Information on specific assets can then be reviewed in more depth, allowing decisions regarding maintenance to be made in a predictive rather than reactive fashion.

The system typically involves a number of components briefly discussed in more detail below.

The sensing device uses an accelerometer (or digital microphone) and thermistor to gather vibration and temperature data, which can be passed to a processor for processing. In this regard, the processor can contain an analog to digital convertor, firmware that performs a Fast Fourier Transform (FFT) process on the vibration data (this converts the vibration time series data to the frequency domain, which is more useful for detecting machine faults), timers that set the data sampling and transmission rate, and a wireless communication device (modem) that allows the data so collected to be uploaded to a local hub via Bluetooth or WiFi protocols. The sensing device can also include custom firmware that optimises battery life by shutting down parts of the sensor hardware except when needed.

The above features enable sensing devices to be installed in seconds using magnetic coupling, and avoiding the need for cabling, permits or drilling. The sensing devices can operate on batteries with a 2 year life-span, which can be further extended using energy harvesting arrangements, thereby further reducing the need for sensor maintenance and replacement.

A hub (which could also be a gateway) is typically used to scan for, and communicate with, multiple sensing devices at a site via Bluetooth or WiFi, or another short range communication protocol. This can be used to store and periodically transmits sensor data securely via a cellular communications network to one or more servers for subsequent analysis.

The central server system is responsible for the storage, processing, analysis, reporting and display of all of sensor data and resulting status information. Typically the server system performs these functions for a number of different customers, allowing each customer to access information regarding their assets on a custom-built display Dashboard. In one example, customers can log into this dashboard and monitor, in near real-time, the temperature and vibration status, and any trend in the value of these parameters, for all their machines. The dashboard will also show the location of the sensors at each site for each customer as a map view, and the status of each machine, and a single page overview of the status of all monitored machines for each customer. Users can ‘click through’ the machine shown on the map view or the single page view to see images of each site, each machine and other useful information, such as the machine manufacturer's nameplate.

The central server system can also contain machine learning algorithms that are initially set to ‘learn’ the normal operating parameters of each machine via the received sensor data, and then switch to ‘operate’ mode where any changes in the normal operation are detected and can trigger alarms. The alarm levels can be set for each parameter of each machine, and will display and email an alarm message to a nominated person for each machine if a parameter on that machine exceeds its alarm level. It will be appreciated however that the use of a central server is only one option, and alternatively other processing arrangements could be used. Whilst there can be discrete learning and operating modes, this is not essential, and in practice, the system will typically undergo a training period and then gradually transition to an ongoing monitoring phase. As this occurs, and optionally on an ongoing basis, feedback can be provided, with this being used for ongoing training of the machine learning algorithms. For example, if the algorithm identifies an issue with operation of a machine, manual inspection of the machine can be performed, with this being used to verify whether or not an issue exists, allowing further machine learning to be performed.

In any event, the ability to use machine learning analytic algorithms to analyse signals from the sensing devices enables the system to ‘auto-learn’ the behaviour of the machine being monitored, thereby reducing the need for human experts to calibrate or customise. This simplifies the process for a much broader scale adoption over existing competitors products which require calibration, expert installation and complete software configuration.

The centralized process also allows the data to be hosted and presented via an intuitive visual interface, meaning users can use the system with little or no training. This also allows maintenance teams to be productive immediately, without the need for hours or days of training.

Additionally, in one example, the client device could be adapted to assist users during an installation process, for example by displaying information guiding the customers to self-install the sensors and gateways via a guided process, that also configures the central system with information about the customer, site and machines being monitored that will appear on the dashboard when the customer's Users log in.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers.

Persons skilled in the art will appreciate that numerous variations and modifications will become apparent. All such variations and modifications which become apparent to persons skilled in the art, should be considered to fall within the spirit and scope that the invention broadly appearing before described.

1-61. (canceled)

62. A monitoring system for monitoring a machine, the monitoring system including:
a) at least one monitoring device including:
i) a housing;
ii) a coupling that physically attaches the housing to the machine;
iii) a plurality of sensors, the plurality of sensors including a vibration sensor that senses vibration transmitted from the machine to the vibration sensor at least in part via the coupling;
iv) a monitoring device processor that:
(1) acquires sensors signals from the plurality of sensors; and,
(2) generates sensor data at least partially in accordance with signals from the sensors;
v) a transmitter that transmits the sensor data; and,
b) one or more processing systems that:
i) receive the sensor data;
ii) analyse the sensor data to determine a machine status; and,
iii) at least one of:
(1) store an indication of the machine status as part of machine status data associated with the respective machine; and,
(2) cause a status indication indicative of the machine status to be displayed.

63. A monitoring system according to claim 62, wherein the vibration sensor includes a microphone acoustically coupled to the machine at least in part via a rigid mechanical coupling member and wherein the microphone is provided adjacent a first end of a cavity and the rigid coupling member includes a projection extending from the housing to a second end of the cavity, to thereby couple vibrations to the microphone via the cavity.

64. A monitoring system according to claim 63, wherein at least one of:
a) the cavity is an opening provided in a circuit board, the microphone being mounted on the circuit board;
b) the microphone is a microelectromechanical microphone provided in a housing having an opening facing the cavity; and,
c) the projection includes:
i) an isolation member in abutment with the circuit board to isolate the cavity from external noise; and,
ii) a flattened tip extending into the cavity, such that movement of the tip generates pressure fluctuations within the cavity, the pressure fluctuations corresponding to the vibrations.

65. A monitoring system according to claim 62, wherein the coupling includes a magnet fixed to the housing and wherein the coupling includes a cup containing the magnet so that the cup engages the machine to thereby transmit vibrations from the machine to the housing.

66. A monitoring system according to claim 65, wherein the coupling includes at least one of:
a) a number of teeth that engage the machine in use to thereby at least one of:
i) assist in securing the monitoring device to the machine; and,
ii) assist in transmitting vibrations from the machine to the monitoring device housing; and,
b) a surface shaped to conform to an outer surface of the machine to thereby at least one of:
i) assist in securing the monitoring device to the machine; and,
ii) assist in transmitting vibrations from the machine to the monitoring device housing.

67. A monitoring system according to claim 62, wherein the sensor data includes at least one of:
a) a monitoring device identifier;
b) signals from the sensors; and,
c) one or more parameters derived from signals from the sensors.

68. A monitoring system according to claim 62, wherein the monitoring device at least partially processes the sensor signals.

69. A monitoring system according to claim 62, wherein the system:
a) uses signals from one or more sensors during a first time period to establish reference behavior for the machine; and,
b) uses signals from the one or more sensors and the reference behavior to determine a machine status.

70. A monitoring system according to claim 69, wherein the system:
a) uses signals from one or more sensors to generate reference data indicative of the reference behavior, the reference data being indicative of at least one of:
i) signals from the one or more sensors;
ii) parameters derived from signals from the one or more sensors;
iii) patterns derived from signals from the one or more sensors;
iv) reference thresholds derived from the signals from the one or more sensors; and,
v) reference ranges derived from the signals from the one or more sensors; and,
b) determines operational data using signals from the one or more sensors, the operational data being based on at least one of:
i) signals from the one or more sensors;
ii) parameters derived from signals from the one or more sensors; and,
iii) patterns derived from signals from the one or more sensors; and,
c) determines a machine status at least in part based on the reference data and signals from the one or more sensors by comparing the operational data to the reference data.

71. A monitoring system according to claim 62, wherein the system assesses the machine status at least in part using machine learning techniques.

72. A monitoring system according to claim 71, wherein the system uses machine learning techniques to:
a) identify at least one category of behavior for the machine from the reference behavior; and,
b) determine the machine status by analyzing signals from the one or more sensors to categorize a current behavior based on the at least one category.

73. A monitoring system according to claim 62, wherein the system analyses signals from the one or more sensors with respect to reference behavior determined during corresponding time intervals during which the machine is expected to exhibit similar behavior.

74. A monitoring system according to claim 62, wherein the system:
a) monitors changes in machine status over time; and,
b) at least one of:
i) stores an indication of changes in machine status as part of machine status data associated with respective machine;
ii) cause a status indication indicative of the change in machine status to be displayed.

75. A monitoring system according to claim 62, wherein the system:
a) uses signals from one or more sensors during a calibration time period when the monitoring device is attached to a calibration machine to establish calibration data; and, uses the calibration data to interpret signals from the sensors when the monitoring device is attached to the machine; and,
b) analyses signals from the vibration and movement sensors; and uses signals from the movement sensor to dynamically calibrate the vibration sensor.

76. A monitoring system according to claim 62, wherein the system:
a) determines a monitoring device integrity by at least one of:
i) analysing signals from a humidity sensor to determine changes in humidity within the housing; and, using changes in humidity to determine at least one of:
(1) if the housing has been breached; and,
(2) if a housing seal has failed; and,
ii) analysing signals from a light sensor to determine changes in light levels within the housing; and, using changes in light levels to determine at least one of:
(1) if the housing has been breached; and,
(2) if a housing seal has failed; and,
b) selectively generates an alert depending on results of the determination.

77. A monitoring system according to claim 62, wherein the system determines if the monitoring device has been moved by:
a) analysing signals from a movement sensor to determine at least one of:
i) movement; and,
ii) a change in orientation;
b) analysing signals from a microphone to determine a change in noise levels; and,
c) determine a wireless network signal strength to determine a change in position of the transmitter relative to a receiver.

78. A monitoring system according to claim 62, wherein the system includes at least one hub that:
a) receives sensor data from a plurality of monitoring devices; and,
b) transfers the sensor data to the one or more processing devices via a communications network.

79. A monitoring device for use in monitoring a machine, the monitoring device including:
a) a housing;
b) a coupling that physically attaches the housing to the machine;
c) a plurality of sensors, the plurality of sensors including a vibration sensor that senses vibration of the machine transmitted to the vibration sensor at least in part via the coupling;
d) monitoring device processor that generates sensor data in accordance with signals from the sensors; and,
e) a transmitter that transmits the sensor data, allowing the sensor data to be transferred via a communications network.

80. A method for monitoring a machine, the method including:
a) receiving sensor data from a monitoring device attached to the machine, the sensor data being generated at least in part based on signals from a plurality of sensors, the plurality of sensors including a vibration sensor that senses vibration of the machine transmitted to the monitoring device via a coupling;
b) analysing the sensor data to determine a machine status; and,
c) at least one of:
i) store an indication of the machine status; and,
ii) cause an indication of a machine status to be displayed.
